(19) United States
(12) Patent Application Publication
(10) Pub. No.: US 2024/0310307 A1
(43) Pub. Date: Sep. 19, 2024

(54) SYSTEM AND METHOD FOR X-RAY IMAGING OF BATTERY LAYERS DURING MANUFACTURING

(71) Applicant: Curpow Inc., Santa Cruz, CA (US)

(72) Inventors: Michael LeClair, Santa Cruz, CA (US); Ian Jenkins, Aptos, CA (US)

(21) Appl. No.: 18/605,640

(22) Filed: Mar. 14, 2024

Related U.S. Application Data
(60) Provisional application No. 63/490,979, filed on Mar. 17, 2023.

(51) Int. Cl. G01N 23/18; G01N 23/044; G01N 23/083; G01N 23/16; G01T 1/20; H01M 10/04

(52) U.S. Cl. CPC G01N 23/18; G01N 23/044; G01N 23/083; G01N 23/16; G01T 1/2002; G01T 1/20186; G01T 1/20187; H01M 10/0404; G01N 2223/505; G01N 2223/611

(57) ABSTRACT

An apparatus is configured to monitor a plurality of layers of a battery layer stack during manufacturing. The apparatus includes at least one X-ray source configured to generate X-rays with X-ray energies that exhibit contrast of transmission through the plurality of layers of the battery layer stack. The at least one X-ray source is configured to face a first side of the battery layer stack. The apparatus further includes at least one sensor configured to detect the X-rays transmitted through the plurality of layers. The at least one sensor is configured to face a second side of the battery layer stack.

### CLAIM OF PRIORITY

This application claims the benefit of priority to U.S. Provisional Appl. No. 63/490,949 filed Mar. 17, 2023, which is incorporated in its entirety by reference herein.

### BACKGROUND

### Field

This application relates generally to monitoring battery fabrication processes.

### Description of the Related Art

Batteries are becoming more important as demand for environmentally clean and portable energy storage has been increasing in popularity. As new battery containing products are released, batteries are subjected to new physical and electrical requirements. (See, e.g., A. Kwade et al., “Current Status and Challenges for Automotive Battery Production Technologies,” Nature Energy 3, no. 4, pp. 290-300 (2018).) These changes in battery requirements can cause changes in how batteries are manufactured which can have a significant impact on the yield of newer battery products. New products have increased the number of batteries being produced globally, such as battery powered vehicles, lawn care equipment, and backup storage for residential and commercial facilities. The increase in the number of batteries produced has made losses in manufacturing much more costly.

### SUMMARY

In certain implementations, an apparatus is configured to monitor a plurality of layers of a battery layer stack during manufacturing. The apparatus comprises at least one X-ray source configured to generate X-rays with X-ray energies that exhibit contrast of transmission through the plurality of layers of the battery layer stack. The at least one X-ray source is configured to face a first side of the battery layer stack. The apparatus further comprises at least one sensor configured to detect the X-rays transmitted through the plurality of layers. The at least one sensor is configured to face a second side of the battery layer stack.

In certain implementations, a system comprises an apparatus comprising at least one X-ray source configured to generate X-rays and to direct the X-rays towards a first side of a battery layer stack comprising a plurality of layers. The apparatus further comprises at least one sensor configured to detect the X-rays transmitted through the plurality of layers. The at least one sensor faces a second side of the battery layer stack, the second side opposite to the first side. The system further comprises at least one battery rolling mechanism configured to fabricate the battery layer stack and a feedback subsystem. The feedback subsystem is configured to generate feedback signals in response to information from the apparatus and to transmit the feedback signals to the at least one battery rolling mechanism to maintain alignment of the plurality of layers during fabrication.

### BRIEF DESCRIPTION OF THE DRAWINGS

FIG. 1 schematically illustrates three example types of battery configurations of a battery comprising a battery layer stack comprising a plurality of layers in accordance with certain implementations described herein.

FIG. 2A schematically illustrates an example battery rolling mechanism configured to fabricate the battery layer stack in accordance with certain implementations described herein.

FIG. 2B schematically illustrates a cross-sectional view of an example edge portion of the plurality of layers of the battery layer stack in a plane substantially perpendicular to the plurality of layers in accordance with certain implementations described herein.

FIGS. 3A-3D schematically illustrate various example apparatus in accordance with certain implementations described herein.

FIG. 4 schematically illustrates at least one X-ray source and at least one sensor on opposite sides of the battery layer stack in accordance with certain implementations described herein.

FIG. 5A is an example plot of calculated X-ray transmissions from the at least one X-ray source through the battery layer stack with a first set of layer thicknesses as a function of X-ray energy in accordance with certain implementations described herein.

FIGS. 5B and 5C are plots of the calculated difference in X-ray transmission between each layer stack for FIG. 5A at a range of X-ray energies in accordance with certain implementations described herein.

FIG. 6A is an example plot of calculated X-ray transmissions from the at least one X-ray source through the battery layer stack with a second set of layer thicknesses as a function of X-ray energy in accordance with certain implementations described herein.

FIGS. 6B and 6C are plots of the calculated difference in X-ray transmission between each layer stack for FIG. 6A at a range of X-ray energies in accordance with certain implementations described herein.

FIG. 7 is a flowchart of an example method in accordance with certain implementations described herein.

FIG. 8 schematically illustrates an example sensor comprising a dual scintillator in accordance with certain implementations described herein.

### DETAILED DESCRIPTION

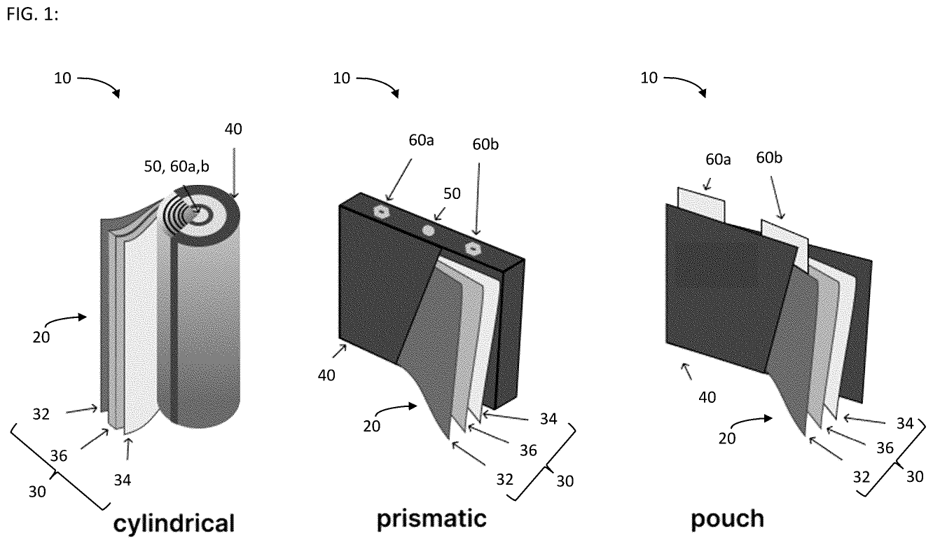

FIG. 1 schematically illustrates three example types of battery configurations of a battery 10 (e.g., lithium ion battery) comprising a battery layer stack 20 comprising a plurality of layers 30 in accordance with certain implementations described herein. Besides the battery layer stack 20, the battery 10 can comprise an electrically conductive housing 40 (e.g., metal case; metalized foil pouch; aluminum-plastic film), a pressure relief vent 50, and positive and negative anode and cathode terminals 60a,b. For a battery 10 having a cylindrical (e.g., jelly roll) battery configuration, prismatic battery configuration, or pouch battery configuration, the plurality of layers 30 of the battery layer stack 20 can include an anode layer 32, a cathode layer 34, and at least one electrically insulative (e.g., plastic) separator layer 36 between the anode layer 32 and the cathode layer 34. For example, the at least one separator layer 36 can comprise a first separator layer 36a between the anode layer 32 and the cathode layer 34 and a second separator layer 36b on an opposite side of the anode layer 32 from the first separator layer 36a. One or both of the first and second separator layers 36a,b can be wider than the cathode layer 34 and the anode layer 32 to allow for some misalignment during final assembly without the anode layer 32 and the cathode layer 34 coming into contact with each other (e.g., electrically shorting with one another). The anode layer 32 can be made to be wider than the cathode layer 34 so that the battery 10 can maintain its electrical properties in the case that the anode layer 32 and the cathode layer 34 become slightly misaligned. If the cathode layer 34 does move beyond the anode layer 32, the battery 10 may not perform as expected. Misalignment of the anode layer 32, cathode layer 34, and at least one separator layer 36 can be a major cause of failure in battery manufacturing.

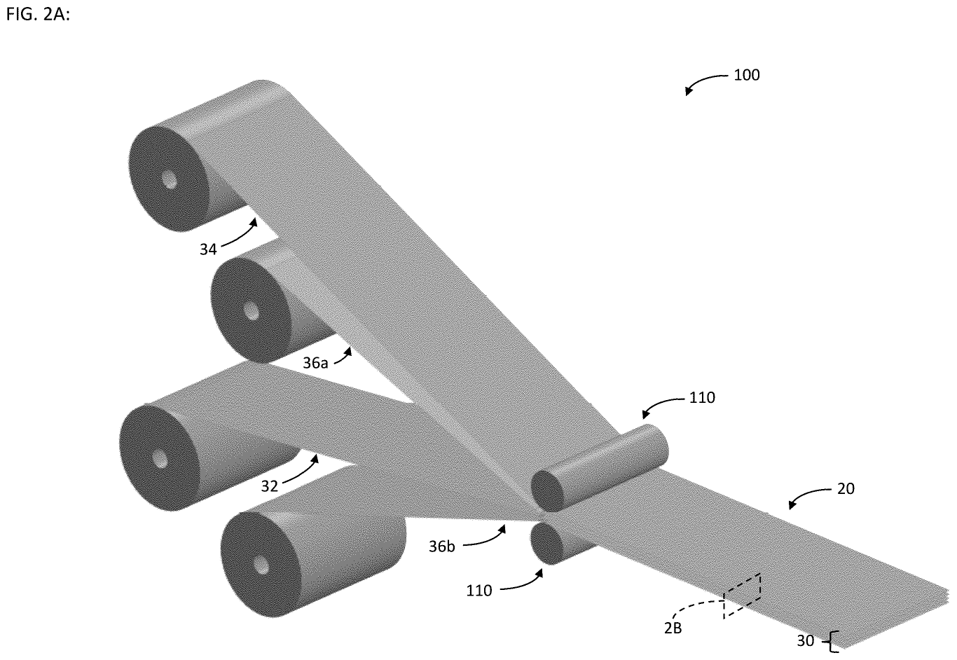

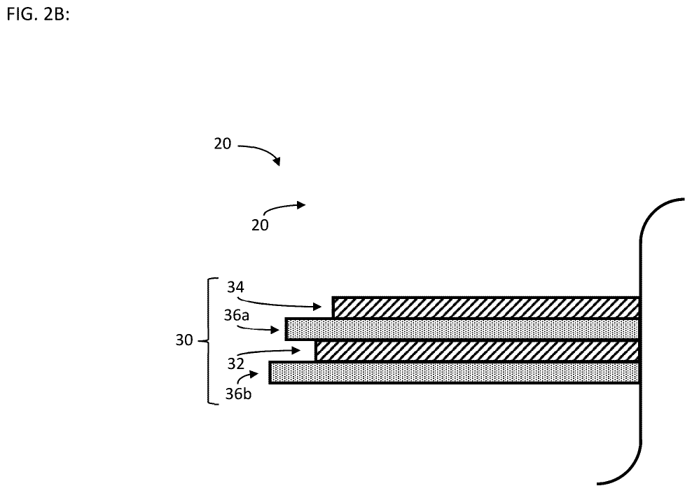

FIG. 2A schematically illustrates an example battery rolling mechanism 100 (e.g., winding assembly) configured to fabricate the battery layer stack 20 in accordance with certain implementations described herein. The battery rolling mechanism 100 comprises a plurality of rollers 110 configured to receive the layers 30 of the plurality of layers 30 (e.g., the anode layer 32, the cathode layer 34, the first separator layer 36a, the second separator layer 36b) of the battery layer stack 20 and to join the layers 30 together to form the battery layer stack 20.

FIG. 2B schematically illustrates a cross-sectional view of an example edge portion of the plurality of layers 30 of the battery layer stack 20 in a plane substantially perpendicular to the plurality of layers 30 in accordance with certain implementations described herein. As shown in FIG. 2B, during the fabrication of the battery layer stack 20, the edges of two or more of the anode layer 32, the cathode layer 34, the first separator layer 36a, the second separator layer 36b can be displaced relative to one another (e.g., the edges all of the layers 30 can be displaced relative to one another). For example, these displacements can be along a direction substantially perpendicular to the layers 30 (e.g., interlayer spacings) and/or along a direction substantially parallel to the layers 30 (e.g., lateral displacements). For example, as shown in FIG. 2B, the edge of the first separator layer 36a is to the left of the edge of the cathode layer 34, the edge of the anode layer 32 is to the left of the edge of the first separator layer 36a, and the edge of the second separator layer 36b is to the left of the edge of the anode layer 32. As shown in FIG. 2B, the edges of the first and second separator layers 36a,b can extend beyond the edge of the anode layer 32 and the edge of the cathode layer 34 (e.g., to electrically insulate the anode layer 32 and the cathode layer 34 from one another). Other relative positions of the edges of the layers 30 are also compatible with certain implementations described herein. Certain implementations described herein provide an apparatus 200 configured to monitor the plurality of layers 30 of the battery stack layer 20 (e.g., the relative positions of the edges of the layers 30) during manufacturing.

Line scan cameras and laser profilometers have been able to measure alignment of the layers in manufacturing production lines. However, this method is only effective so long as all layers in the battery layer stack 20 are thin enough to produce reasonable contrast as it relies on wavelength of light near or within the visible portion of the electromagnetic spectrum.

One of the new demands placed on battery performance, especially for electric vehicles, is higher energy densities. One way that battery manufacturers are able to increase energy density is by increasing the thickness of the electrode (e.g., anode; cathode) layers 32,34. (See, e.g., J. Billaud et al., “Magnetically Aligned Graphite Electrodes for High-Rate Performance Li-Ion Batteries,” Nature Energy 1, no. 8, p. 16097 (2016).) However, such thickness increases of the anode and the cathode layers 32,34 can make inline optical and laser methods of measuring layer alignment ineffective.

Certain implementations described herein provide an apparatus and/or a method for measuring battery layer alignment (e.g., electrode layers 32,34; separator layers 36a,36b) using X-ray imaging. For example, certain implementations described herein can measure a distance between layers 30 of battery materials before the layers 30 are rolled or stacked into a final assembly. For another example, certain implementations described herein can track and measure positions of edges of the layers 30 relative to one another (e.g., the different layers 30 having different mass densities and different X-ray absorption coefficients). In certain implementations, the apparatus and/or method also allows for measurements of defects in battery layers 30, contamination, and layer thickness. Certain implementations described herein provide an apparatus and/or method for measuring battery layer alignment using feedback from X-ray measurements to automatically realign the layers 30 to increase an assembly yield of the final battery fabrication process.

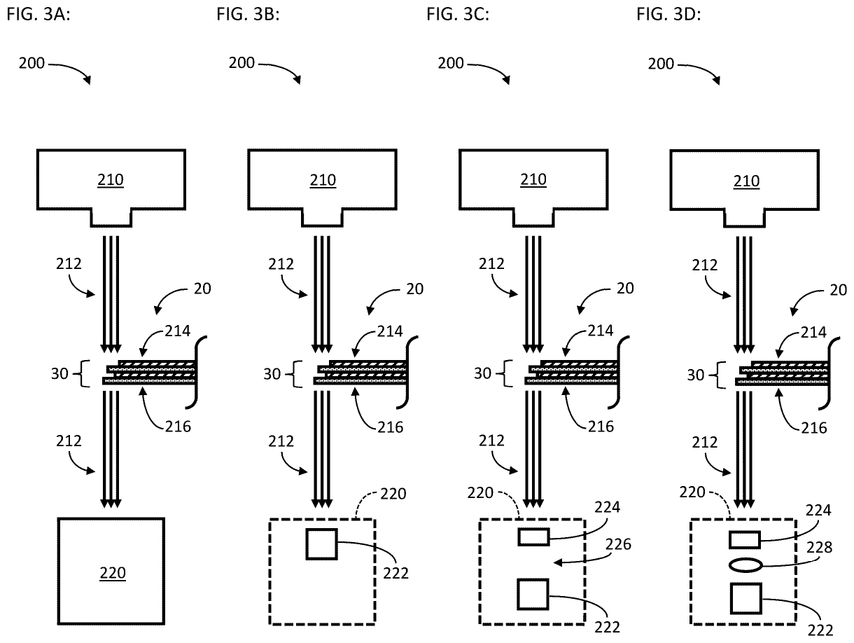

FIGS. 3A-3D schematically illustrate various example apparatus 200 in accordance with certain implementations described herein. The apparatus 200 comprises at least one X-ray source 210 configured to generate X-rays 212 with energies that exhibit contrast of transmission through the plurality of layers 30 of the battery layer stack 20. The at least one X-ray source 210 is configured to face a first side 214 of the battery layer stack 20. The apparatus 200 further comprises at least one sensor 220 (e.g., X-ray detector) configured to detect the X-rays 212 transmitted through the plurality of layers 30. The at least one sensor 220 is configured to face a second side 216 of the battery layer stack 20, the second side 216 is opposite to the first side 214.

For example, the at least one X-ray source 210 can comprise an X-ray tube and the at least one sensor 220 can comprise an X-ray detector, the x-ray tube and the X-ray detector located on opposite sides of a location at which the layers 30 of the battery layer stack 20 are stacked with one another (e.g., the X-ray detector is below the battery layer stack 20 and the X-ray tube is above the battery layer stack 20). In certain implementations, the at least one X-ray source 210 and the at least one sensor 220 are located such that the edges of the layers 30 of the battery layer stack 20, the at least one X-ray source 210, and the at least one sensor 220 are substantially colincar with one another, with the at least one X-ray source 210 spaced from the edges of the layers 30 by a first distance in a first direction and the at least one sensor 220 spaced from the edges of the layers 30 by a second distance in a second direction substantially opposite to the first direction. Portions of the at least one sensor 220 can be spaced apart from one another periodically along a lateral direction substantially parallel to the plurality of layers 30 and in a field of view of the at least one X-ray source 210. The relative positions of the edges of the layers 30 (e.g., the edges of the anode layer 32, the cathode layer 34, the first separator layer 36a, and the second separator layer 36b) can be monitored by detecting (e.g., imaging) X-rays 212 from the at least one X-ray source 210 that are transmitted through the layers 30 and received by the at least one sensor 220.

Certain implementations described herein provide a method for measuring the spacings between layers 30 of a battery layer stack 20 using X-ray absorption contrast imaging. For example, the method can comprise placing the battery layer stack 20 between at least one X-ray source 210 and at least one sensor such that some of the X-rays 212 produced by the at least one X-ray source 210 pass through the layers 30 of the battery layer stack 20 (e.g., the first separator layer 36a, the anode layer 32, the second separator layer 36b, and the cathode layer 34) and are detected by the at least one sensor 220. The method can further comprise using the at least one sensor 220 to measure differences in photon counts across a lateral area of the battery layer stack 20 (e.g., in a plane substantially parallel to the layers 30 of the battery layer stack 20). The X-rays 212 are absorbed more (e.g., fewer X-rays 212 are transmitted through) in the portions of the area where there are more layers 30 present according to the Beer-Lambert Law:

I=Iₒe^{μρd},

where Iₒ is the number of incident X-rays 212, I is the number of transmitted X-rays 212, μ is the mass absorption coefficient of the material (which is dependent on the X-ray energy and the atomic element of the material), ρ is the material density of the material, and d is the material thickness (e.g., in a direction substantially perpendicular to the lateral area of the battery layer stack 20). Because the materials in one or more of the layers 30 can contain composite materials, the mass absorption coefficient for the material can be expressed as the sum of the products of the weight percentage, wᵢ, and the mass attenuation coefficient for each element:

μₘₐₜₑᵣᵢₐₗ=Σwᵢμₑₗₑₘₑₙₜ.

To calculate the transmission of the X-rays 212 through multiple layers 30, certain implementations run the calculation for each layer 30 of the battery layer stack 20, where the number of incident X-rays 212 for each subsequent layer 30 is the number of X-rays 212 transmitted through the prior layer 30.

To achieve good contrast between layers 30 (e.g., sufficient contrast to distinguish the different layers 30 from one another), certain implementations use low energy X-rays 212 such that each layer 30 attenuates a significant percentage of the X-rays 212 (e.g., the at least one X-ray source 210 can be configured to generate X-rays 212 having an optimum energy). For example, if one layer 30, positioned overhanging another layer 30, were to attenuate too many X-rays 212, then there would not be enough X-rays 212 to define contrast between other layers 30 with any statistical significance. Conversely, if not enough X-rays 212 are absorbed by the material of the layer 30, then the at least one sensor 220 will not show any significant difference between those layers 30. Plastic separator layers 36a,b can be very thin with materials having low atomic weight, so in certain implementations, the low energy the X-rays 212 are selected to provide sufficient contrast in those layers 30.

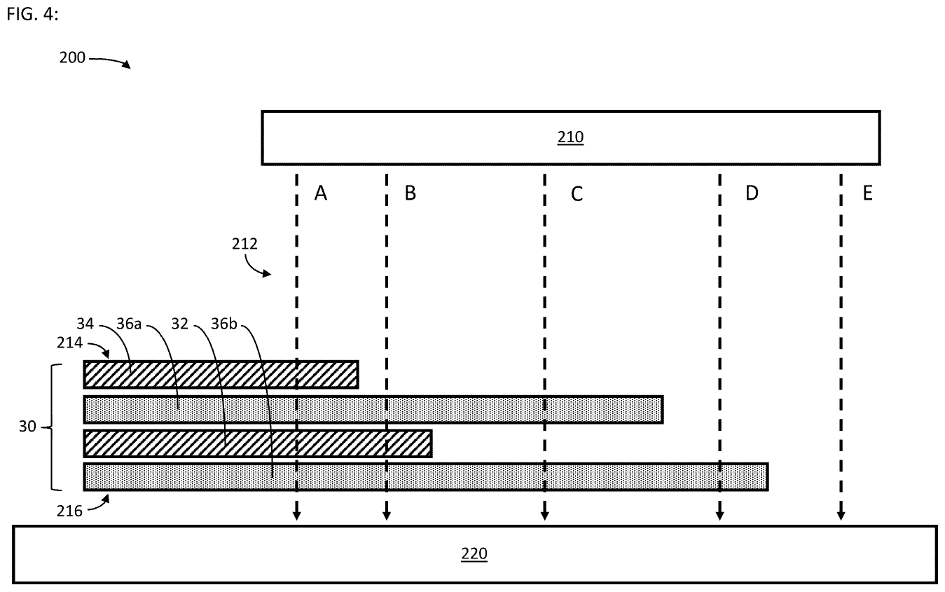

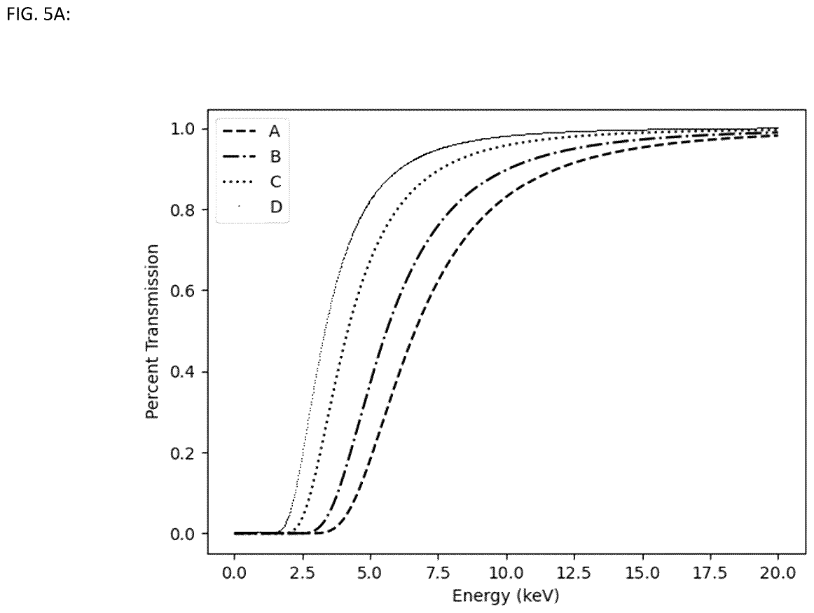

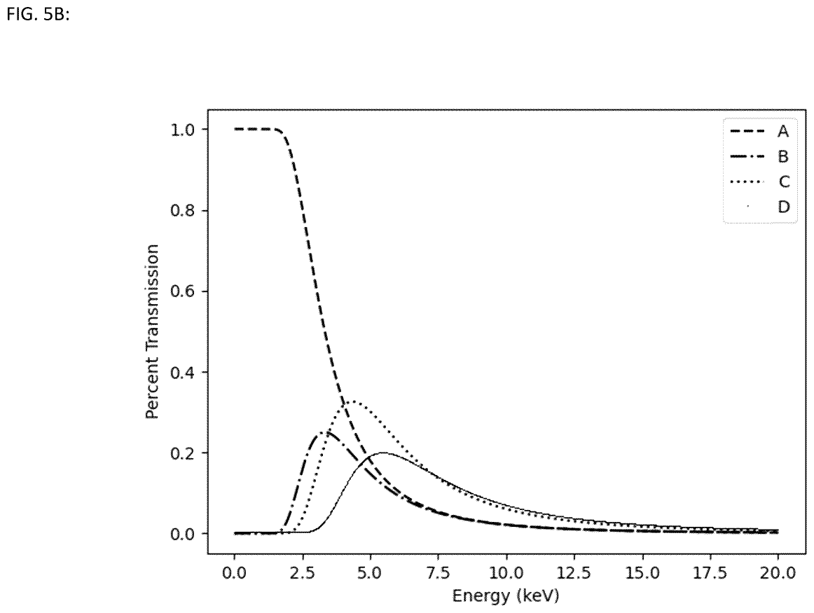

In certain implementations, the optimum energy of the X-rays 212 produced by the at least one X-ray source 210 are calculated by comparing the differences of the transmission of each section of the battery layer stack 20. For example, FIG. 4 schematically illustrates at least one X-ray source 210 and at least one sensor 220 on opposite sides 214, 216 of the battery layer stack 20 (e.g., comprising the cathode layer 34, the first separator layer 36a, the anode layer 32, and the second separator layer 36b) in accordance with certain implementations described herein. The X-rays 212 propagating from the at least one X-ray source 210, through the battery layer stack 20, to the at least one sensor 220 are also schematically illustrated by dashed lines. Some of the X-rays 212 propagate through the cathode layer 34, the first separator layer 36a, the anode layer 32, and the second separator layer 36b (denoted as layer group “A”), some of the X-rays 212 propagate through the first separator layer 36a, the anode layer 32, and the second separator layer 36b (denoted as layer group “B”), some of the X-rays 212 propagate through the first separator layer 36a and the second separator layer 36b (denoted as layer group “C”), some of the X-rays 212 propagate through the second separator layer 36b (denoted as layer group “D”), and some of the X-rays 212 propagate through none of the cathode layer 34, the first separator layer 36a, the anode layer 32, and the second separator layer 36b (the empty set denoted by layer group “E”).

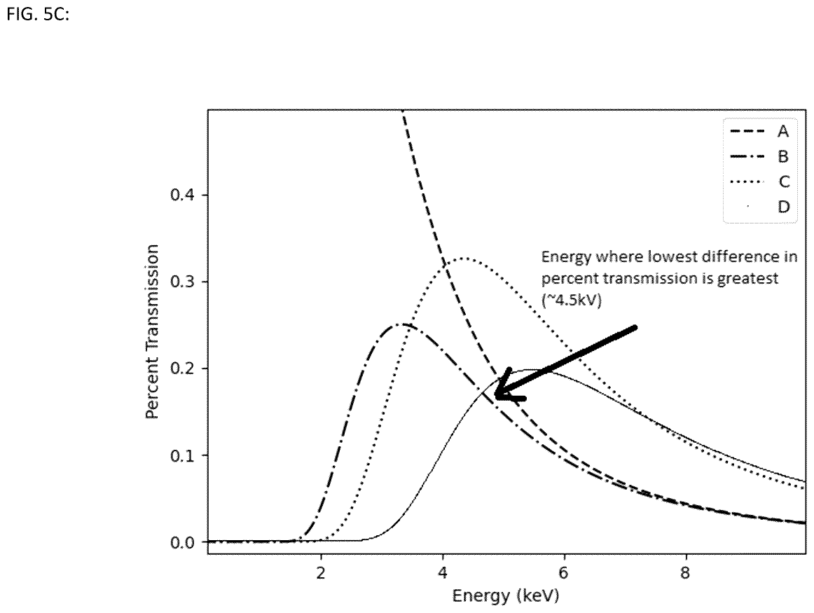

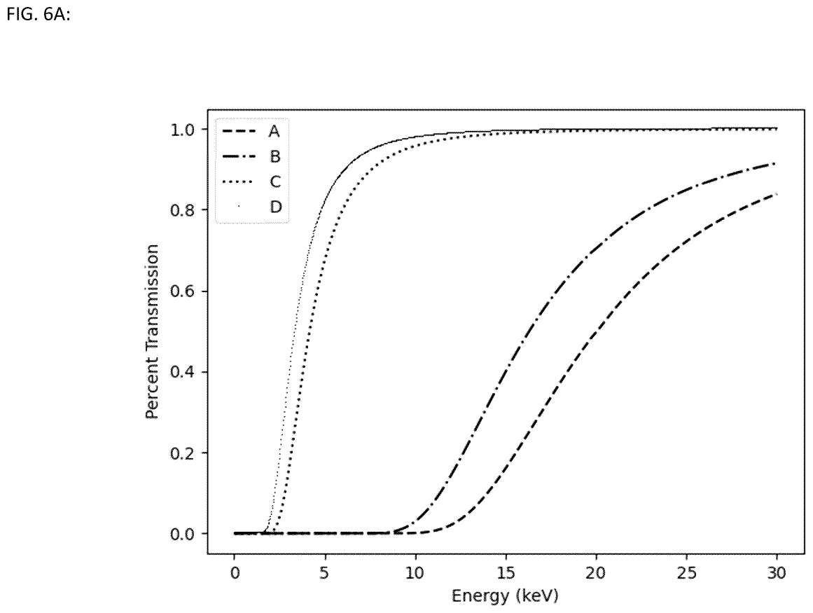

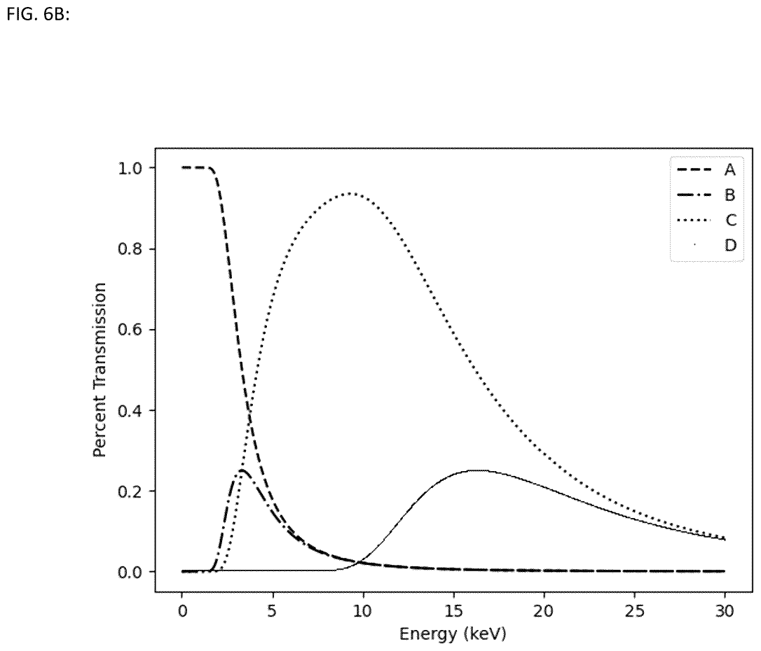

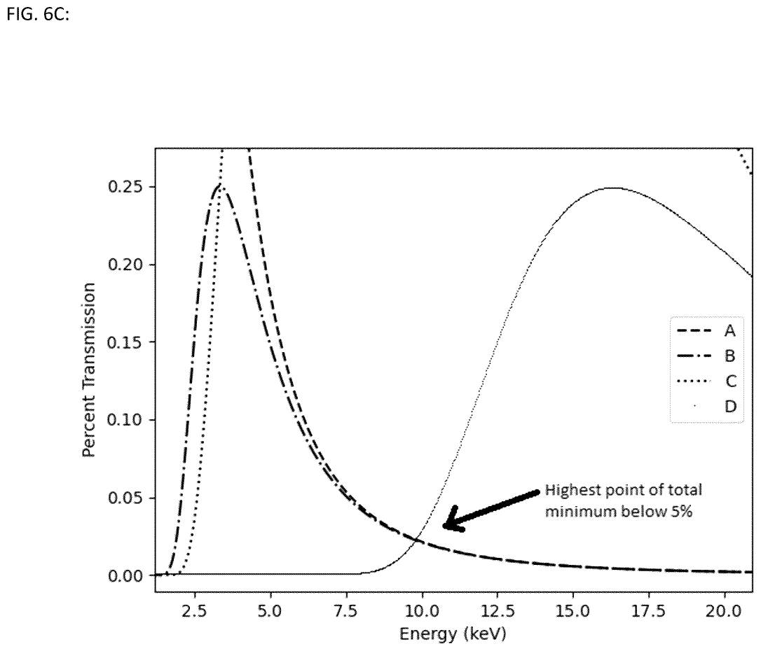

FIGS. 5A and 6A are example plots of calculated X-ray transmissions from the at least one X-ray source 210 through the denoted layer groups of the battery layer stack 20 (e.g., layer group A, B, C, and D) to the at least one sensor 220 as a function of X-ray energy in accordance with certain implementations described herein. For the calculated X-ray transmissions of FIG. 5A, each of the first and second separator layers 36a,b is 50 microns thick, the cathode layer 34 is 150 microns thick, and the anode layer 32 is 180 microns thick. For the calculated x-ray transmissions of FIG. 6A, each of the first and second separator layers 36a,b is 50 microns thick, the cathode layer 34 is 8.05 millimeters thick, and the anode layer 32 is 8.08 millimeters thick. FIGS. 5B and 6B are plots of the calculated difference in X-ray transmission between each layer stack for FIGS. 5A and 6A, respectively, at a range of X-ray energies. FIGS. 5C and 6C are the same plots as FIGS. 5B and 6B, respectively, but over a smaller X-ray energy range.

The optimal contrast can be at the x-ray energy where the minimum of all functions is at the greatest magnitude of transmission, which can be represented mathematically as:

ƒₘᵢₙ(x)=min({ƒ₁(x),ƒ₂(x),ƒₙ(x)}).

In this function, ƒ₁ (x) to ƒₙ(x) represent the difference in X-ray transmission between layers 30 where x is X-ray energy. ƒₘᵢₙ (x) is a function that represents the minimum value for each difference in X-ray transmission for all sections in the battery layer stack 20. The X-ray energy where ƒₘᵢₙ (x) is greatest can yield the X-ray energy where contrast between layers 30 is optimal, which can be represented by the following (e.g., assuming x is the X-ray energy from the at least one X-ray source 210 that produces the optimal contrast between layers 30):

x=argmax(ƒₘᵢₙ(x)).

The amount of contrast that is sufficient is dependent on the noise of the system. The difference in mean contrast between two regions divided by the standard deviation can be considered to be the contrast-to-noise ratio. While some of the standard deviation can be the square root of the number of counts due to poisson statistics, the other part of the standard deviation can be a combination of thermal noise, shot noise, and dark current, all of which can be highly dependent on the sensor design. In certain implementations, the amount of contrast considered to be sufficient is determined experimentally.

Because such low energy X-rays 212 have substantial attenuation from air, certain implementations take into account the air attenuation between the battery layer stack 20 and the at least one sensor 220. For example, the X-ray absorption of air can be calculated using the Beer-Lambert law, where the elemental composition and weight percentages according to documented ratios can be used to determine the mass attenuation coefficient. The density of air at standard temperatures and pressure can be used and the path length is the distance between the window of the at least one X-ray source 210 and the battery layer stack 20 plus the distance between the battery layer stack 20 and the at least one sensor 220.

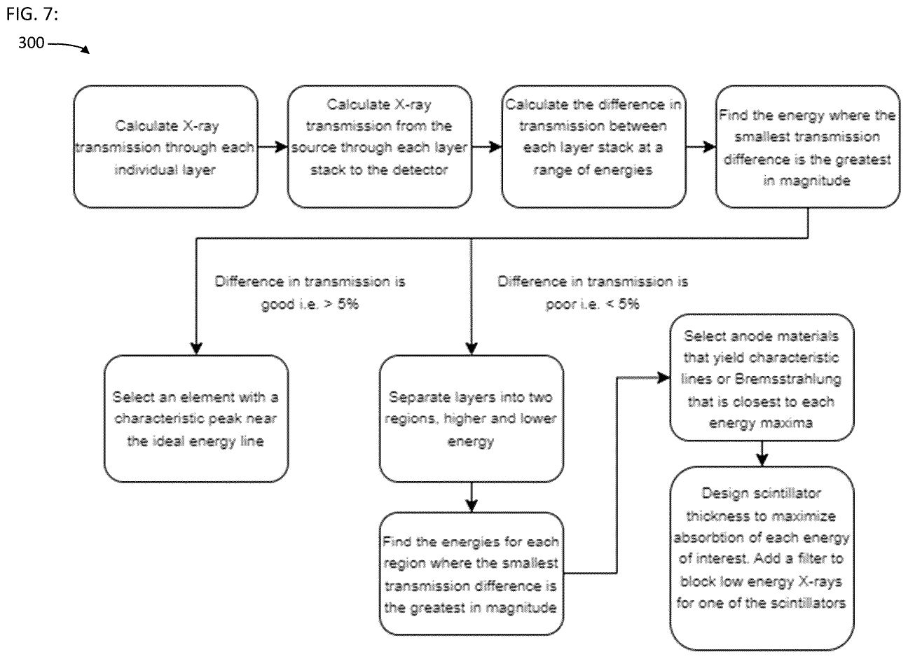

Because the layers 30 for different battery layer stacks 20 can have different layer thicknesses and material compositions, certain implementations utilize at least one X-ray source 210 (e.g., X-ray tube) configured to output a majority of X-rays 212 at specific X-ray energies (e.g., below 10 keV). For example, X-ray energies can be selected by looking at a table of characteristic X-ray lines and selecting an atomic element with X-ray lines closest to the area where contrast is maximized for the battery layer stack 20. While X-ray tubes are polychromatic, their output tapers to zero at the accelerating voltage or kV edge. They also can produce a large number of X-rays 212 at the characteristic lines of the anode material (e.g., characteristic X-ray lines below 10 keV). Calculating the X-ray tube output can be done by many methods, see, e.g., ‘Pella’, ‘Ebel’, and ‘Finkelshtein and Pavlova’. In certain implementations, however; a first order approximation can be made by calculating the transmission curve of each layer 30 over an X-ray energy range, then selecting an X-ray tube anode material that has a characteristic X-ray line where each section of the battery layer stack 20 has an X-ray transmission greater than zero and less than 100%. For example, the X-ray energies can be below 10 keV and configured for imaging layers comprising atomic elements with low atomic numbers (e.g., atomic elements with atomic numbers below 14). As seen in FIG. 5C, the X-ray energy where the minimum of all the curves is greatest can be near 4.5 keV, so the at least one X-ray source 210 can use a titanium anode material having a characteristic X-ray Kα line at 4.51 keV to yield an optimal contrast. If the x-ray energy at which the greatest contrast for the battery layer stack 20 were around 6.7 keV, then the at least one X-ray source 210 can use an iron anode material having a characteristic X-ray Kα line at 6.4 keV or can use a cobalt anode material having a characteristic X-ray Kα line at 6.9 keV. FIG. 7 is a flowchart of an example method 300 in accordance with certain implementations described herein. FIGS. 6A-6C correspond to the flowchart branch beginning with “separate layers into two regions, higher and lower energy.”

In certain implementations in which some regions of the battery layer stack 20 has a total X-ray transmission close to 100% or 0%, to avoid impractical acquisition times, the at least one X-ray source 210 can be configured to produce X-rays 212 having different X-ray energies. For example, an X-ray tube anode can have multiple atomic elements mixed, alloyed, or placed near each other so that the electron beam of the X-ray tube interacts with the multiple atomic elements. For example, tungsten and chromium can be alloyed or placed in proximity to one another at the X-ray tube anode to produce strong characteristic X-ray lines around 10 keV and around 5.8 keV. For another example, molybdenum and copper can be placed in proximity to one another at the X-ray tube anode to produce strong characteristic X-ray lines around 17.5 keV and around 8 keV. A high-powered X-ray tube with a large number of bremsstrahlung X-rays that span the predetermined energy regions for sufficient contrast in the layers can also be used (e.g., a 100 W tungsten anode tube).

In certain implementations, the at least one sensor 220 is configured to detect the X-rays 212 transmitted through the battery layer stack 20 (e.g., X-rays 212 having X-ray energies in a range of 3 keV to 8 keV). For example, as shown in FIG. 3B, the at least one sensor 220 can comprise at least one one-dimensional (1D) or two-dimensional (2D) pixelated semiconductor sensor 222 configured to directly detect X-rays 212 (e.g., silicon-based TDI, CCD, or CMOS-based sensor available commercially from various vendors; 2D pixelated CdTe or CZT sensor). For another example, as shown in FIGS. 3C and 3D, the at least one sensor 220 can comprise at least one scintillator 224 and at least one 1D or 2D pixelated semiconductor sensor 222 for higher efficiency (see, e.g., M. S. Kim et al., “A comparative study of scintillator combining methods for flat-panel X-ray image sensors,” doi.org/10.1016/j.nima.2017.11.023; E. Durbaric et al., “Resolution and noise properties of scintillator coated X-ray detectors,” Nucl. Instr. And Methods in Phys. Res. A 466, pp. 178-182 (2001)). In certain implementations, the at least one scintillator 224 can be coupled directly to the at least one semiconductor sensor 222 (see, e.g., FIG. 3C) or to at least one lens 228 configured to focus the visible light on the at least one semiconductor sensor 222 (see, e.g., FIG. 3D). In certain implementations, the at least one X-ray source 210 (e.g., X-ray tube) is configured to produce incident X-rays 212 that yield a predetermined contrast between all layers 30 of the battery layer stack 20.

In certain implementations in which multiple X-ray energies are used to get good contrast, multiple scintillators 224 (e.g., two) can be placed on the same lens 228. The thickness of each scintillator 224 can act as a low pass energy filter for the detected X-rays 212 (e.g., to allow 90% X-ray transmission at energies above 8 keV). In certain implementations, the at least one scintillator 224 can comprise at least one attenuator material 230 comprising one or more materials (e.g., carbon, aluminum, copper, gold) affixed to a top surface of the at least one scintillator 224 facing the layers 30, the one or more materials configured to attenuate at least some of the X-rays 212 so as to act as a high pass energy filter for incident X-rays 212. In certain implementations, an air gap 226 between the at least one semiconductor sensor 222 and the at least one scintillator 224 can also act as a high pass energy filter. By optimizing the thickness of the at least one scintillator 224 (e.g., low pass energy filter configured to allow 90% X-ray transmission at energies above 8 keV), and the thickness and material type of the at least one attenuator material 230 (e.g., high pass energy filter), certain implementations comprise at least one notch filter configured such that the at least one scintillator 224 produces visible light in response to X-rays 212 within a specific X-ray energy range. Because high energy X-rays 212 interact with semiconductor materials, the at least one semiconductor sensor 222 of certain implementations is not placed directly below the lens 228. A mirror 232 can be used to reflect the visible light from the at least one scintillator 224 by a non-zero angle to the at least one semiconductor sensor 222 (e.g., reflected by an angle approximately equal to 90 degrees). Analysis of the two different sections on the at least one semiconductor sensor 222 can yield contrast of different sections of the battery layer stack 20.

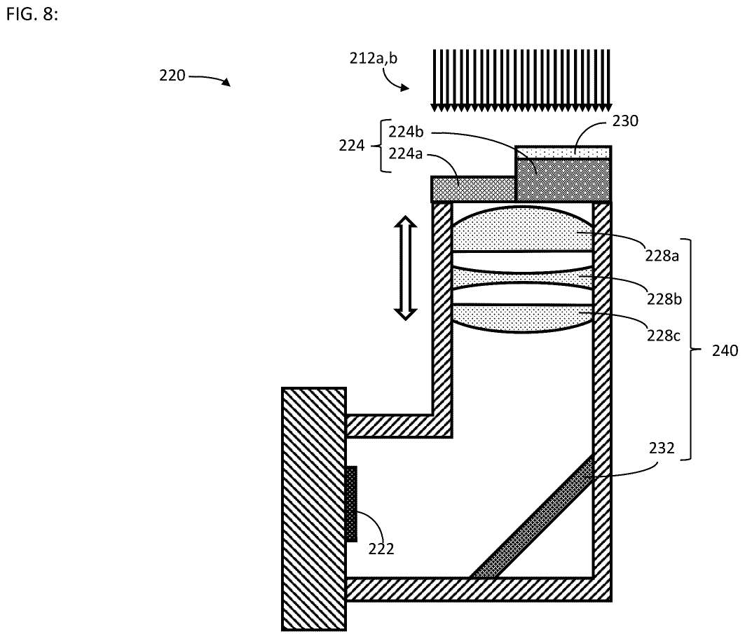

FIG. 8 schematically illustrates an example sensor 220 comprising a dual scintillator 224 in accordance with certain implementations described herein. The sensor 220 comprises a first scintillator 224a having a first thickness and a second scintillator 224b having a second thickness greater than the first thickness. For example, the first thickness can be optimized for first X-rays 212a having a first X-ray energy range and the second thickness can be optimized for second X-rays 212b having a second X-ray energy range greater than the first X-ray energy range. For example, each scintillator 224a,b can have a different thickness configured to absorb a different portion of the X-rays 212 transmitted through the layers 30, the different portions having different X-ray energies. The sensor 220 further comprises at least one attenuator material 230 (e.g., low energy filter) on at least one scintillator 224 of the first and second scintillators 224a,b (e.g., the second scintillator 224b). The at least one attenuator material 230 can be configured to substantially block low energy X-rays 212 from the at least one scintillator 224 (e.g., the at least one attenuator material 230 and the at least one scintillator 224 acting as an energy notch filter).

The sensor 220 of FIG. 8 further comprises at least one pixelated semiconductor sensor 222 and a visible light optical subsystem 240 between the first and second scintillators 224a,b and the at least one pixelated semiconductor sensor 222. The optical subsystem 240 is configured to focus visible light from the dual scintillator 224 at the at least one pixelated semiconductor sensor 222. For example, as seen in FIG. 8, the optical subsystem 240 can comprise at least one lens 228 (e.g., one or more focus lenses 228a,b,c) and a mirror 252. The one or more focus lenses 228a,b,c can be configured to be movable (denoted in FIG. 8 by a double-headed arrow). The one or more focus lenses 228a,b,c can be controllably moved individually, relative to one another and/or together, as a unit to adjust a focus of the optical subsystem 240. The mirror 252 deflects the visible light from the one or more focus lenses 228a,b,c towards the at least one pixelated semiconductor sensor 222.

In certain implementations, the at least one sensor 220 is configured to generate images indicative of the X-rays 212 transmitted through the battery layer stack 20. For example, the at least one X-ray source 210 can comprise multiple X-ray tubes configured such that the plurality of layers 30 can be moved between the at least one sensor 220 and the multiple X-ray tubes such that images generated by the at least one sensor 220 can be reconstructed as at least one laminographic image. The apparatus 200 can be configured to analyze the images to generate information about an alignment of the layers 30 and/or defects and contamination among the layers 30. To identify which layer 30 has the defect (e.g., in the portion of the image where there are multiple layers 30), certain implementations utilize multiple sensors 220 within the cone angle of the at least one X-ray source 210. A laminographic 2D depth or 3D reconstruction can be performed in certain implementations using the known battery layer speed as the layers 30 move past each sensor 220 and using the time delayed images collected by the multiple sensors 220 to identify the location of defects, damage, or contamination within the layers 30 before the battery layer stack 20 is assembled. In certain implementations, the contrast of the images is calibrated with the same materials of known thickness, and the thickness of the individual layers 30 can be measured as well.

For example, the apparatus 200 can comprise a computing device configured to analyze the at least one laminographic image to determine at least one of: a thickness of at least one layer 30 of the plurality of layers 30, a variation of thickness of at least one layer 30 of the plurality of layers 30 along a lateral direction substantially parallel to the plurality of layers 30, an order and/or positions of the layers 30 of the plurality of layers 30, and/or at least one defect, damage, or contamination of the plurality of layers 30. The computing device can be configured to use the information generated by the apparatus 200 to perform at least one of: monitoring positions of one or more edges of the layers 30 of the plurality of layers 30 and identifying defects, damage, and/or contamination computationally or through machine learning algorithms.

The computing device can comprise a processing unit (e.g., microprocessor; application-specific integrated circuits; generalized integrated circuits programmed by software with computer executable instructions; microelectronic circuitry; microcontrollers) executing a software application compatible with certain implementations described herein. The processing unit can comprise or can be in operative communication with storage circuitry to store information (e.g., data; commands) accessed by the processing unit during operation (e.g., while providing the functionality of certain examples described herein). The storage circuitry can comprise a tangible (e.g., non-transitory) computer readable storage medium, examples of which include but are not limited to: read only memory (ROM); random access memory (RAM); magnetic disk storage media; optical storage media; flash memory. The storage circuitry can be encoded with software (e.g., a downloaded computer program) comprising computer executable instructions for instructing the processing unit (e.g., executable data access logic, evaluation logic, and/or information outputting logic). The processing unit can execute the instructions of the software to provide functionality as described herein. Examples of the computing device include, but are not limited to: notebook computer; laptop computer; smartphone; smart tablet. The computing device can also comprise one or more peripheral devices, examples of which include, but are not limited to: user input or output device; keyboard; mouse; trackball; touchpad; pen; pointer; display device (e.g., image projector); computer memory device. The computing device can also be in operational communication with another computing device (e.g., server) via a network, examples of which include, but are not limited to: the Internet, Ethernet networks, wide area networks (WAN), wireless local area networks (WLAN), wireless fidelity (WiFi) networks, wireless gigabit alliance (WiGig) networks, wireless personal area networks (WPAN).

In certain implementations, the apparatus 200 is configured to use the measurements outlined herein to provide feedback to battery manufacturers about alignment, defects, damage, or contamination with the layers during fabrication of the battery layer stack. For example, the apparatus 200 can be configured to use information regarding the measured relative positions of the edges of the layers 30 to automatically realign misaligned layers 30. The apparatus 200 can use this information (e.g., in real-time during fabrication of the battery layer stack 20) to generate feedback signals in response to the information. In certain implementations, the apparatus 200 transmits the feedback signals to the battery rolling mechanism 100 to automatically (e.g., without human intervention) and controllably adjust operational aspects of the battery rolling mechanism 100 (e.g., the plurality of rollers 110). The battery rolling mechanism 100 can be configured to respond to the feedback signals by maintaining alignment of the plurality of layers 30 to a predetermined degree during fabrication (e.g., sufficiently aligned so that the battery layer stack 20 can continue to be rolled reliably; to prevent telescoping of the layers 30; such that the resultant battery layer stack 20 performs electrically to predetermined specifications). In certain other implementations, the feedback signals can be configured to pause the battery rolling mechanism 100 so that human intervention can be initiated to manually align the layers 30 of the plurality of layers 30 with one another and/or to remove one or more layers 30 of the plurality of layers 30.

In certain implementations in which the battery layer stack 20 is configured to be used in pouch batteries, the images can be used to identify the spacing between anode layer 32 and the cathode layer 34 while the battery layer stack 20 is being assembled (e.g., in real-time). For example, an image of the battery layer stack 20 can be used as a flat field normalization for the next subsequent layer 30 so that the position of the new layer 30 can be determined relative to the other layers 30 that have already been placed. Certain such implementations determine misalignments of the electrode layers 32,34 while the battery 10 is being assembled.

In certain implementations, the system can use machine learning algorithms to analyze the images to identify problematic defects, damage or contamination and/or to set limits on when and how to align based on feedback from analysis done after the layers 30 are assembled into battery layer stacks 20. For example, parameters such as defect size, location, alignment variance at various locations during winding can be recorded. Batteries can then be inspected after final assembly using current destructive methods and/or non-destructive methods (e.g., industrial CT), and information can be recorded about the quality and performance of the batteries after assembly. Machine learning algorithms, such as the k-nearest neighbor algorithm, can then be implemented to find relationships between failure modes and data taken during inline inspection. If, for example, batteries having a certain number of defects and variance in alignment tend toward a particular failure mode, then limits can be set production to predict if a battery 10 will likely pass, will likely fail, or will need further inspection. Certain such implementations can help increase throughput by limiting how many parts need final inspection without sacrificing quality. Certain such implementations can increase throughput and limit unnecessary intervention from the system.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements, and/or steps are in any way required for one or more implementations. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Conjunctive language such as the phrase “at least one of X, Y, and Z,” unless specifically stated otherwise, is to be understood within the context used in general to convey that an item, term, etc. may be either X, Y, or Z. Thus, such conjunctive language is not generally intended to imply that certain implementations require the presence of at least one of X, at least one of Y, and at least one of Z.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. While the structures and/or methods are discussed herein in terms of elements labeled by ordinal adjectives (e.g., first, second, etc.), the ordinal adjectives are used merely as labels to distinguish one element from another, and the ordinal adjectives are not used to denote an order of these elements or of their use.

Various configurations have been described above. It is to be appreciated that the implementations disclosed herein are not mutually exclusive and may be combined with one another in various arrangements. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various implementations and examples discussed above may be combined with one another to produce alternative configurations compatible with implementations disclosed herein. Various aspects and advantages of the implementations have been described where appropriate. It is to be understood that not necessarily all such aspects or advantages may be achieved in accordance with any particular implementation. Thus, for example, it should be recognized that the various implementations may be carried out in a manner that achieves or optimizes one advantage or group of advantages as taught herein without necessarily achieving other aspects or advantages as may be taught or suggested herein.

1. An apparatus configured to monitor a plurality of layers of a battery layer stack during manufacturing, the apparatus comprising:
at least one X-ray source configured to generate X-rays with X-ray energies that exhibit contrast of transmission through the plurality of layers of the battery layer stack, the at least one X-ray source is configured to face a first side of the battery layer stack; and
at least one sensor configured to detect the X-rays transmitted through the plurality of layers, the at least one sensor configured to face a second side of the battery layer stack.

2. The apparatus of claim 1, wherein the at least one sensor comprises at least one pixelated 1D or 2D semiconductor sensor configured to directly detect the transmitted X-rays.

3. The apparatus of claim 1, wherein the at least one sensor comprises:
at least one scintillator configured to receive the transmitted X-rays and to generate light in response to the received X-rays; and
at least one pixelated semiconductor sensor configured to directly receive the light from the at least one scintillator.

4. The apparatus of claim 1, wherein the at least one sensor comprises:
at least one scintillator configured to receive the transmitted X-rays and to generate light in response to the received X-rays;
at least one lens configured to receive the light from the at least one scintillator; and
at least one pixelated semiconductor sensor, the at least one lens configured to focus the light from the at least one scintillator onto the at least one pixelated semiconductor sensor.

5. The apparatus of claim 1, wherein the at least one sensor comprises:
at least one scintillator configured to receive the transmitted X-rays and to generate light in response to the received X-rays;
at least one lens configured to receive the light from the at least one scintillator;
at least one mirror configured to receive the light from the at least one lens; and
at least one pixelated semiconductor sensor, the at least one lens configured to focus the light from the at least one scintillator and the at least one mirror configured to reflect the focused light onto the at least one pixelated semiconductor sensor.

6. The apparatus of claim 5, wherein the at least one mirror is configured to reflect the light from the at least one lens by a non-zero angle to the at least one pixelated semiconductor sensor.

7. The apparatus of claim 6, wherein the angle is approximately 90 degrees.

8. The apparatus of claim 5, wherein the at least one scintillator has a thickness configured to provide a low pass energy filter.

9. The apparatus of claim 5, wherein the at least one scintillator comprises at least two scintillators, each scintillator having a different thickness configured to absorb a different portion of the transmitted X-rays.

10. The apparatus of claim 9, wherein the different portions have different energies.

11. The apparatus of claim 9, further comprising an attenuator material on one scintillator of the at least two scintillators, the at least one attenuator material configured to block low energy X-rays from the one scintillator such that the attenuator material and the one scintillator act as an energy notch filter.

12. The apparatus of claim 1, wherein portions of the at least one sensor are spaced apart from one another periodically along a lateral direction substantially parallel to the plurality of layers and in a field of view of the at least one X-ray source.

13. (canceled)

14. The apparatus of claim 1, further comprising a computer system configured to analyze information from the at least one sensor to determine at least one of:
a thickness of at least one layer of the plurality of layers;
a variation of thickness of at least one layer of the plurality of layers along a lateral direction substantially parallel to the plurality of layers;
an order and/or positions of the layers of the plurality of layers; and
at least one defect, damage, or contamination of the plurality of layers.

15. A system comprising:
an apparatus comprising:
at least one X-ray source configured to generate X-rays and to direct the X-rays towards a first side of a battery layer stack comprising a plurality of layers; and
at least one sensor configured to detect the X-rays transmitted through the plurality of layers, the at least one sensor facing a second side of the battery layer stack, the second side opposite to the first side;
a battery rolling mechanism configured to fabricate the battery layer stack; and
a feedback subsystem configured to generate feedback signals in response to information from the apparatus and to transmit the feedback signals to the battery rolling mechanism to maintain alignment of the plurality of layers during fabrication.

16. The system of claim 15, wherein the feedback subsystem comprises a computing device configured to use the information from the apparatus to perform at least one of:
monitoring positions of one or more edges of the layers of the plurality of layers; and
identifying defects, damage, and/or contamination computationally or through machine learning algorithms.

17. The system of claim 16, wherein the feedback signals are configured to pause the battery rolling mechanism so that human intervention can be initiated to manually align the layers of the plurality of layers with one another and/or to remove one or more layers of the plurality of layers.

18. The system of claim 16, wherein the feedback signals are configured to automatically align the layers of the plurality of layers with one another without human intervention.

19. The system of claim 16, wherein the computing device is configured to prevent telescoping of the layers of the plurality of layers.
